(19) United States
(12) Patent Application Publication
(10) Pub. No.: US 2026/0139104 A1
(43) Pub. Date: May 21, 2026

(54) METHODS AND SYSTEMS ASSOCIATED WITH A HIGH CONCENTRATION SLURRY FORMULATIONS

(71) Applicant: NNA Polymers, Inc., Houston, TX (US)

(72) Inventors: Chao Yang, Houston, TX (US); Jianbo Sun, Shandong Province (CN); Yongsheng Xu, Shandong Province (CN)

(73) Assignee: NNA Polymers, Inc., Houston, TX (US)

(21) Appl. No.: 19/385,276

(22) Filed: Nov. 11, 2025

Related U.S. Application Data
(60) Provisional application No. 63/720,857, filed on Nov. 15, 2024.
(60) Provisional application No. 63/720,829, filed on Nov. 15, 2024.

(51) Int. Cl. C08J 3/11

(52) U.S. Cl. CPC C08J 3/11; C08J 2333/26

(57) ABSTRACT

High concentration polymer slurries contain up to 70 weight percent active polymer in a hydrophobic solvent base treated with suspending agents, dispersants, and thinning agents. The slurries are prepared by mixing a solid polymer with an invert polymer emulsion without the need for specialized field equipment. These slurries provide increased polymer concentration and improved dispersibility of solid polymer or other hydrophilic colloids. The resulting formulations offer technical advantages, including enhanced efficiency, ease of handling, and cost-effectiveness.

### CROSS-REFERENCE TO RELATED APPLICATIONS

This application claims a benefit of priority under 35 U.S.C. § 119 to Provisional Application No. 63/720,829 and Provisional Application No 63720857 filed Nov. 15, 2024, which are fully incorporated herein by reference in its entirety.

### BACKGROUND INFORMATION

### Field of the Disclosure

Examples of the present disclosure relate to polymer slurry formulations, and more particularly to high-concentration slurry systems including water-soluble or hydrophilic polymers dispersed in hydrophobic solvent media. In embodiments, the emulsion remains compatible with a wide array of chemicals by modifying the backbone of the polymer with a reactive surfactant monomer unit (R₁) and a rigid monomer unit (R₂).

### Background

Drilling is a common operation in many industries, from oil and gas. During the drilling, drilling fluids are often circulated in the wellbore to achieve various operations from setting tools, friction reducers, propping open formations, transporting cuttings, maintaining formation pressures, cooling down drill bits, etc.

Emulsions are colloidal dispersions of one liquid in another, typically stabilized by surfactants that reduce interfacial tension and prevent droplet coalescence. In conventional fracturing fluids, the polymer backbone is unmodified, and as such, the stability of the polymer depends entirely on free-floating surfactants that act as a soft, steric barrier for the polymer. However, these free-floating surfactants constrain emulsion compatibility and therefore limit their applications.

In prior art, surfactants act as a surface steric barrier to prevent emulsion droplets from coalescing. However, in conventional slurries, the surfactants are not chemically or physically bonded to the surface of emulsion droplets, i.e., they can freely relocate from one droplet to another or from droplets to solid particles.

Accordingly, needs exist for systems and methods associated with polymer systems that incorporate stabilizing functionalities directly into the polymer backbone to enhance emulsion stability and prevent migration or detachment of the stabilizing agents.

### SUMMARY

Embodiments are directed towards a high-stability emulsion system in which a polymer backbone is physically modified to include a charge moiety (R1) and a rigid moiety (R2). The charge moiety provides electrostatic repulsion between emulsion droplets, and the rigid moiety provides steric repulsion and structural rigidity. The combination of electrostatic and steric stabilization within a single polymer structure reduces coalescence, aggregation, and phase separation, resulting in emulsions that remain stable under thermal, mechanical, or chemical stress.

Furthermore, the stable emulsion may remain compatible with a wide array of chemicals, such as bio-polymers, friction reducers, clays, viscosifiers, etc.

In embodiments, the charge moiety may be a reactive surfactant that is built directly into the polymer backbone, and the rigid moiety may be a rigid monomer built directly into the polymer backbone. These moieties are locked into the molecules of the polymer and cannot freely leave.

In a specific embodiment, the polymer slurry may include a solid polymer, a hydrophobic solvent base oil, an inverse emulsion, and a suspending agent.

The solid polymer may include polyethylene oxide, polysaccharide, polyacrylamide, polyacrylate (SI). The solid polymer may include a repeat unit of saccharide, a repeat unit of ethylene glycol, and the solid polymer is a polyacrylamide, and preferably, the solid polymer is selected from an ionic polyacrylamide (especially an anionic acrylamide) and a neutral polyacrylamide.

The hydrophobic solvent base oil is insoluble in water and does not solvate or swell hydrophilic colloids. The solid polymer may be dispersed in the hydrophobic solvent formulation as solid discrete particles and/or wherein said particles are in the form of powder, granules, or flakes.

The inverse emulsion may be formed of a water-soluble polymer that includes acrylamide repeat units and is an ionic or nonionic polyacrylamide, and said oil phase. The inverse emulsion may include at least 10 wt % of said oil phase; and less than 80 wt % of said oil phase; said inverse emulsion comprises at least 10 wt % and less than 70 wt % of the water-soluble polymer; and the water-soluble polymer incorporates up to 40 wt % of water. In embodiments, the inverse emulsion (E) includes 10-40 wt % of said oil phase, 15-60 wt % of the water-soluble polymer, and 10-40 wt % water. In embodiments, the water-soluble polymer includes one or more moieties selected from —C(O)NH2, —COO—, sulfonate, pyrrolidone, and quaternary ammonium a repeat unit.

The suspending agents facilitate maintenance of polymer particles in suspension, while optional thinning agents and dispersants may be included to adjust viscosity and improve stability. The slurry formulation may include up to 2 weight % suspending agents; and optionally, 0.5-1 weight % thinning agent; and, optionally, 0.1-7.0 weight % dispersant

In embodiments, the slurry may include at least 5 wt %, preferably at least 30 wt %, of the solid polymer; and/or said slurry may include less than 70 wt % or less than 60 wt % of solid polymer; and wherein said formulation includes at least 1 wt %, preferably at least 5 wt %, of inverse emulsion; and/or said formulation includes less than 70 wt % or less than 60 wt % of the inverse emulsion.

This combination yields a high-concentration slurry that is both flowable and stable, without phase separation, and that can be easily diluted or activated at the point of use.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein reference numerals refer to like parts throughout the various views unless otherwise specified.

FIG. 1 depicts an embodiment where particles have electrostatic repulsion.

FIG. 2 depicts an embodiment of steric repulsion.

FIG. 3 depicts a polymer structure 300 of an embodiment.

FIG. 4 depicts a structure of R₁, according to an embodiment

FIG. 5 depicts a structure of R₂, according to an embodiment

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art, that the specific detail need not be employed to practice the present embodiments. In other instances, well-known materials or methods have not been described in detail to avoid obscuring the present embodiments.

Embodiments are directed towards a polymer backbone with a reactive surfactant monomer unit (R₁), and a rigid monomer unit (R₂) having a structure that includes aromatic or conjugated moieties that resist bending and rotation, providing steric hindrance to prevent droplet coalescence. In embodiments, the electrocharged surfactant and rigid moieties may be covalently incorporated into the solid polymer backbone. This allows the emulsion droplets to be internally stabilized by the engineered polymer structure. The resulting high-solid emulsion is produced in a simple, single-step evaporation process. The system requires no added stabilizer. Moreover, our high-solid emulsion is exceptionally thin and highly flowable. By comparison, the high-solid emulsion generated via the prior art is very viscous.

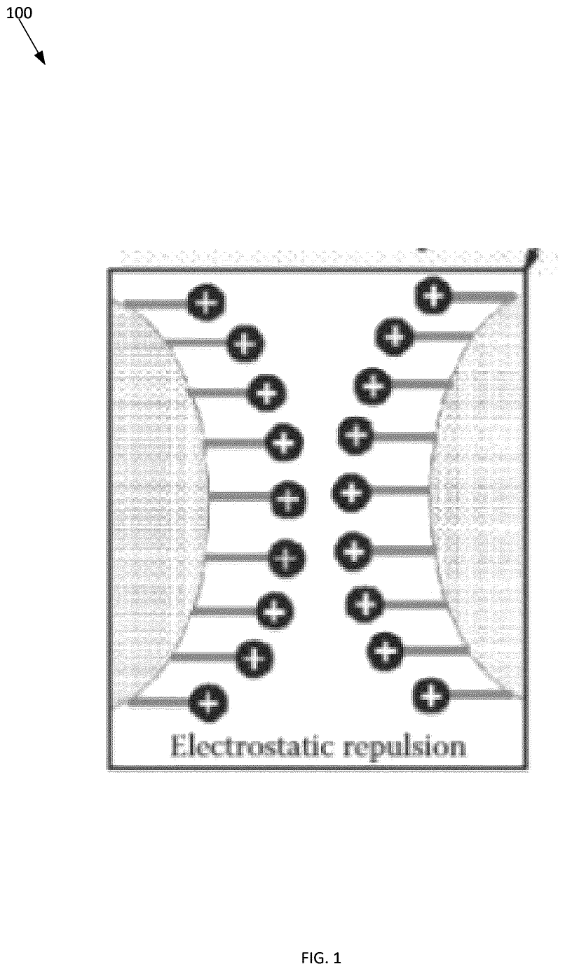

FIG. 1 depicts an embodiment where particles have electrostatic repulsion 100. The force pushes similarly charged particles away from each other, such as two positive charges or two negative charges. This phenomenon is a fundamental concept in physics and is described by Coulomb's Law, which states that the force is directly proportional to the product of the charges and inversely proportional to the square of the distance between them.

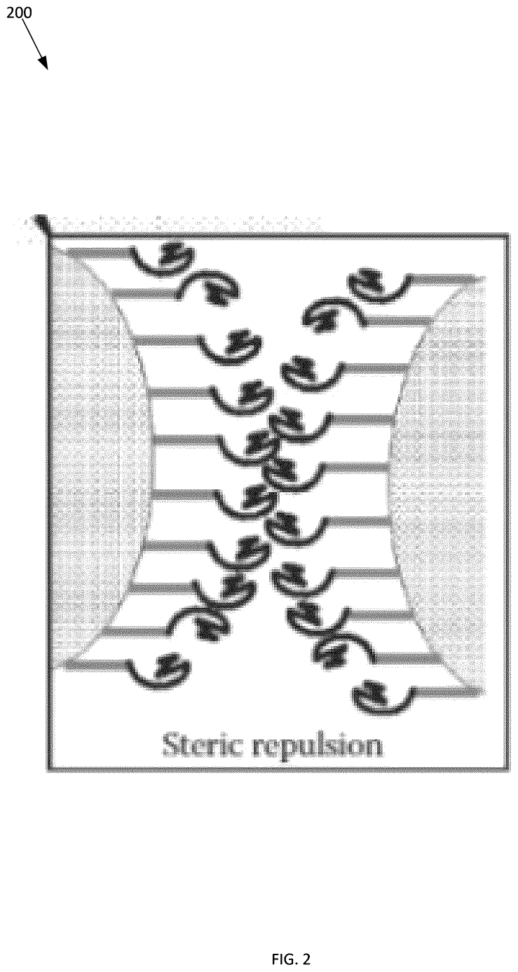

FIG. 2 depicts an embodiment of steric repulsion 200. Steric repulsion is the repulsive force that occurs between atoms or groups of atoms within a molecule when they are too close together, due to their physical size. This happens because the electron clouds of the atoms repel each other, which destabilizes the molecule and can affect its shape and reactivity.

The combination of R₁ and R₂ provides dual repulsion mechanisms. The charge moiety induces electrostatic repulsion between droplets, while the rigid moiety provides steric resistance to droplet coalescence. These mechanisms work synergistically to prevent the emulsion from breaking even under prolonged storage or agitation.

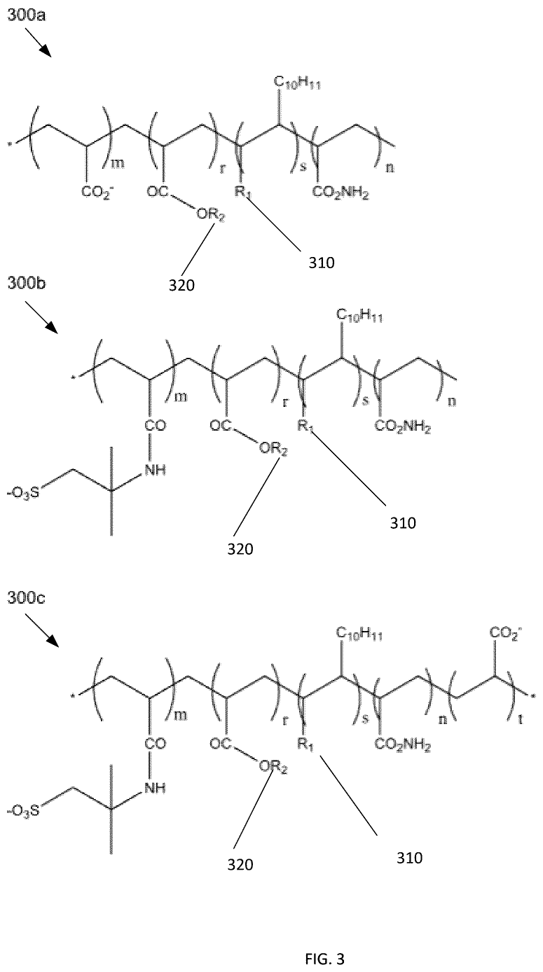

FIG. 3 depicts three polymer structures 300a, 300b, and 300c of an embodiment. As depicted in FIG. 3, the backbone is engineered to include both R₁ 310 and R₂ 320.

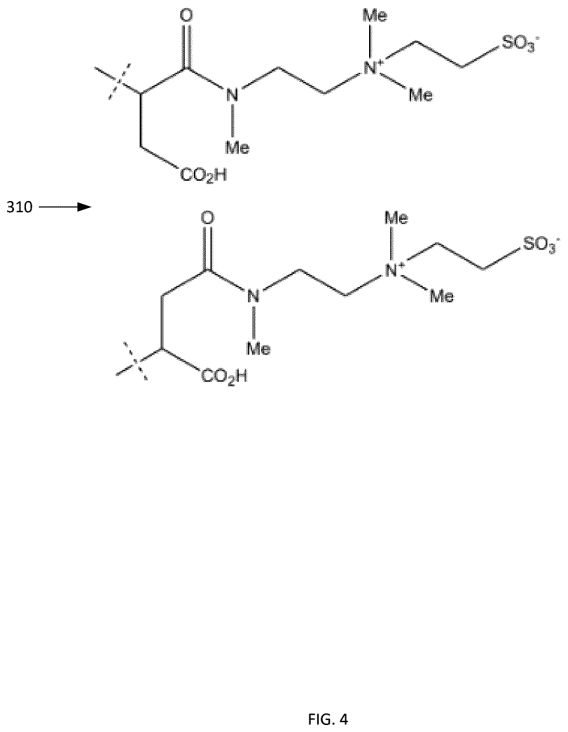

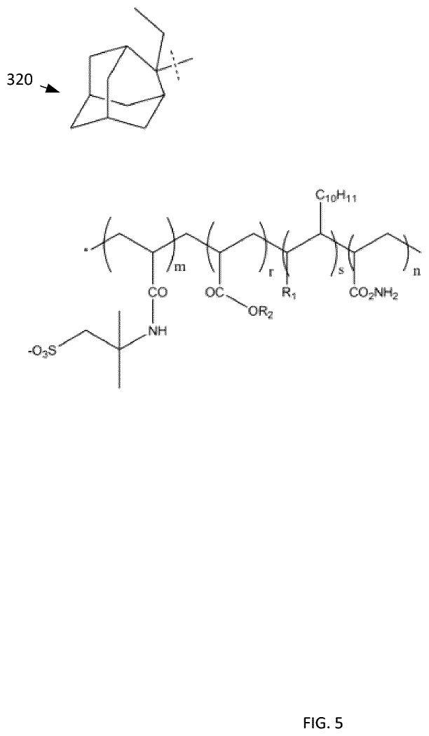

FIG. 4 depicts a structure of R₁ 310 according to an embodiment, and FIG. 5 depicts a structure of R₂ 320 according to an embodiment.

In specific embodiments, The slurry formulation comprises a solid polymer (A), a hydrophobic solvent base oil that is insoluble in water and does not solvate or swell hydrophilic colloids, an inverse emulsion (E) comprising a water-soluble polymer (B), wherein said polymer includes acrylamide repeat units and is an ionic or nonionic polyacrylamide, and a suspending agent to maintain dispersion of the solid polymer within the formulation.

Polymer (A) may include Saccharide-based polymers (e.g., polysaccharides), Ethylene glycol repeat units (e.g., polyethylene oxide), Acrylamide-based polymers, including ionic, anionic, and neutral polyacrylamides. Polymer (A) typically exhibits a molecular weight of at least 1,000 Daltons, more preferably at least 8,000,000 Daltons. The polymer is present in solid particulate form (e.g., powder, granules, flakes) and remains as discrete particles within the hydrophobic solvent phase.

In a specific embodiment, polymer A may include the following formula 1, wherein R1, R2, and R3 independently represent a hydrogen atom or an optionally-substituted (preferably unsubstituted) C1-4 alkyl, preferably C1-2 alkyl, more preferably a methyl group.

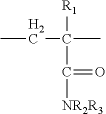

In a specific embodiment, polymer A may include the following formula 2, which is preferably in combination with a repeat unit of formula I, wherein said repeat unit of formula II comprises a moiety. The O* moiety is an O— moiety or is covalently bonded to another atom or group.

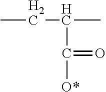

Alternatively, the O* moiety is a repeat unit comprising a moiety of formula 3, shown below.

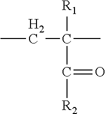

where the R2 group is either:

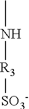

Or

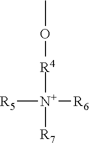

wherein R1, R3, R4, R5, R6 and R7 are independently selected from a hydrogen atom and an optionally-substituted C1-4 alkyl.

Specific embodiments are directed towards stabilizing a high-solid emulsion, while simplifying the polymer enrichment process through direct modification of the polymer backbone. The combination of the rigid and surfactant moieties may create a synergy effect, and the amphoteric nature of surfactant R₁ may contribute to emulsion stability as well. In embodiments, both the surfactant and the rigid moiety are incorporated into the polymer backbone through carbon-carbon single bonds. The polymer backbone remains relatively flexible, not excessively rigid compared with the prior art, but its degree of free rotation and/or polymer folding is restricted by the bulky R₁ and R₂ groups and by electrostatic repulsion. The ratio and amount of R₁/R₂ have been optimized to achieve a desired balance between softness and hardness. In preferred embodiments, the radio may be in the range of 2:0 to 1:51. However, in other embodiments an acceptable ranges may extend from 10:1 to 1:10. To this end, embodiments are directed towards a high-efficiency thickener for fracturing and its preparation method, combining the advantages of both emulsion and dry powder systems. The thickener exhibits rapid dissolution, high salt resistance, strong drag reduction, and superior temperature stability.

This may lead to embodiments to be a dual-function polymer: combines emulsion and dry-powder properties, yielding rapid hydration, strong salt resistance, and >75% drag reduction at 100,000 ppm salinity, with core-shell polymerization, and produces micro-crosslinked particles that resist agglomeration and remain stable during concentration and storage. Additionally, embodiments may include a high solid content (≥65%) with excellent viscosity in both freshwater and brine, with a stable suspension lead to no phase separation or sedimentation observed at 50° C., while also having operational efficiency allowing for lower dosage (50% reduction) and enhanced temperature resistance during large-scale fracturing operations.

Embodiments propose a preparation method of high-efficiency thickener for fracturing in view of the current situation of pressure flooding construction, which can greatly improve the polymer content, and has excellent characteristics of fast dissolution speed, stable performance, strong salt resistance and high drag reduction efficiency at the same time. Embodiments may include a salt-resistant fine powder, high-strength emulsion, high-content base solution, high-efficiency thickener for fracturing

In a specific embodiment, the preparation of salt-resistant fine powder is composed of raw materials of the following weight parts: 150-220 parts of acrylamide, 4-8 parts of associated monomers, 20-150 parts of salt-resistant monomers, 5-10 parts of soluble monomers, 0-29 parts of sodium hydroxide and 583-821 parts of water. The preparation method is as follows: acrylamide, associative monomer, salt resistant monomer, soluble monomer and water are mixed evenly, the pH value of the system is adjusted to 6.5-7.0 with sodium hydroxide, adjusted to 5-10° C., nitrogen is blown to deoxygenate for 30 min, chain transfer agent, high temperature initiator, oxidant and reducing agent are added to initiate the reaction for copolymerization reaction to obtain a polymer rubber block, the polymer rubber block is granulated, sodium hydroxide and penetrant are added for kneading, and after high temperature curing for 4 h, the salt-resistant fine powder is obtained by granulation, drying, grinding and screening.

The salt-resistant fine powder may be characterized by the preparation of the associated monomer in step (1) of salt-resistant fine powder consisting of the following raw materials: octadecyl succinic anhydride, lauryl ethoxylate, AEO-10 and concentrated sulfuric acid. The preparation method is as follows: add octadecene succinic anhydride and lauryl ethoxyethylene ether AEO-10 to the four-port reactor with stirrer, thermometer, condenser tube and burette, heat the reaction kettle to a certain temperature, open the stirrer after the monomer is completely melted and fully mix evenly, slowly add concentrated sulfuric acid dropwise, continue to keep warm for 4 h after the dropper is completed, the reaction is over, and the associated monomer is obtained.

The salt-resistant fine powder may be characterized by the fact that in the preparation of associative monomers, the mass ratio of octadecyl succinic anhydride and lauryl sulfoxyethylene ether AEO-10 is preferably as follows: octadecyl succinic anhydride and lauryl ethoxyethylene ether AEO-10=1:2; the addition of described concentrated sulfuric acid is 4% of the monomer addition, and the reaction temperature is preferably 72-77° C.;

The preparation of high-strength emulsion may be composed of aqueous phase and oil phase. The aqueous phase is composed of the following weights of raw materials: first aqueous phase: 110-195 parts of acrylamide, 83-167 parts of anionic monomer, 16-94 parts of sodium hydroxide, 300-400 parts of water, Ammonium persulfate 0.1-0.5, second aqueous phase: acrylamide 60-80 parts, anionic monomer 20-40 parts, enhancer 0.1-1 parts, sodium hydroxide 4-22 parts, water 100 parts, ammonium persulfate 0.1-0.5 parts, oil phase: oil solvent 200-240 parts, reactive surfactant 10-15 parts, emulsifier 10-15 parts, rigid monomer 5-10 parts. The preparation method is as follows: the first aqueous phase and the second aqueous phase are dissolved separately, the pH value is adjusted to 7.0 with sodium hydroxide, ammonium persulfate is added and mixed evenly; the emulsification pump is opened, the base oil, reactive surfactant, emulsifier and the first aqueous phase are mixed evenly, and the viscosity of the emulsification system reaches more than 800 mPa·s; After 30 min of nitrogen deoxygenation, sodium bisulfite is pumped to initiate polymerization, the initiation temperature is 20° C., the temperature is kept below 35° C. throughout the reaction, after 3.5 h, the reaction has completed, air is introduced, the second aqueous phase and rigid monomers are added, and the viscosity of the emulsion system reaches more than 1200 mPa·s, after 30 min of nitrogen deoxygenation, sodium bisulfite is pumped to initiate polymerization, and the initiation temperature is 30° C., and the temperature is controlled below 45° C. throughout the reaction, and 1 h later, the reaction proceeds to completion.

The preparation may be characterized by the fact that the anionic monomer in the preparation of the high-strength emulsion in step (2) is one or two of acrylic acid, 2-acrylamino-2-methylpropanesulfonic acid. The rigid monomer is preferably 2-ethyl-2-adamantylalkyl acrylate; with a reinforcing agent preferably that: polyethylene glycol (400) diacrylate; an oil solvent is preferably the solvent oil with boiling point ≥200° C.; and the emulsifier may be preferably sorbitan emulsifier.

The preparation of the reactive surfactant consists of the following raw materials: dodecenylsuccinic acid, N,N,N′-trimethylethylenediamine, catalyst, sodium 2-bromoethanesulfonate, dimethylformamide and water. The preparation method is as follows: dodecenyl succinic acid, N,N,N′-trimethylethylenediamine are added to the four-port reactor with stirrer, thermometer, condenser tube and burette, the reaction kettle is heated to 95° C., the stirrer is fully mixed evenly, the catalyst is slowly added dropwise, nitrogen is filled into the mixed solution for oxygen removal, the reaction is kept warm for 7 h, the water bath temperature is reduced to 85° C., dimethylformamide, sodium 2-bromoethanesulfonate and water are added to the above-mentioned reaction system, and the reaction is carried out for 6 h. The rotary evaporator removes dimethylformamide and water to obtain a reactive surfactant. Wherein, the mass ratio of dodecylsuccinic acid to N,N,N′-trimethylethylenediamine is preferably 5:2; the catalyst is preferably concentrated sulfuric acid, and the dosage is preferably 3% of the monomer dosage; the mass ratio of the dodecylsuccinic acid to sodium 2-bromoethanesulfonate is preferably 5:4. In embodiments, the dimethylformamide addition is 2 times of dodecenylsuccinic acid, and water addition is 2 times of sodium 2-bromoethanesulfonate;

After the high-strength emulsion reaction is completed, the high-content base liquid may be prepared by closing the nitrogen of the reaction kettle, the reaction tank is sealed, the steam circulation heating is opened, the steam pressure reaches a certain range, the circulating vacuum pump is opened, the condensation and dehydration are carried out under the vacuum degree reaches a certain pressure, the condenser circulating water inlet temperature is lower than 10° C., and after the dehydration reaches the dehydration endpoint, the circulating steam, vacuum pump and condenser circulating water are closed to obtain a high-content base liquid.

In embodiments of the high-content base liquid, the vapor pressure range is preferably 0.5-1 MPa, the vacuum degree is preferably −90 KPa-−100 KPa, and the dehydration end point is preferably the dehydration end point when the material temperature rises to 65-80° C.

The preparation of high-efficiency thickener for fracturing is composed of the following weight of raw materials: 50-90 parts of high-content base solution, 10-50 parts of salt-resistant fine powder, 1-3 parts of dispersant, 0.01-3 parts of suspension aid, and 3-8 parts of phase transfer agent. The preparation method is as follows: add a high-content base solution and a phase transfer agent in the reaction kettle, add a dispersant and a suspension aid to mix evenly after stirring evenly, and then add the salt-resistant fine powder and stir evenly, so that the salt-resistant fine powder is completely dispersed to obtain a high-efficiency thickener for fracturing.

In embodiments of the high-efficiency thickener the suspension aid is preferably organobentonite, the dispersant is preferably polyisobutylene succinimide; and the phase transfer agent is preferably fatty alcohol ethoxylate.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A high concentration polymer slurry formulation comprising:
(i) a solid polymer (A) selected from polyethylene oxide, polysaccharide, polyacrylamide, and polyacrylate;
(ii) a hydrophobic solvent base oil that is insoluble in water and does not solvate or swell hydrophilic colloids;
(iii) an inverse emulsion (E) comprising a water-soluble polymer (B) including acrylamide repeat units and an oil phase, wherein the inverse emulsion includes a reactive surfactant monomer unit (R₁), and a rigid monomer unit (R₂) having a structure build into the backbone of the formulation that includes moieties that are configured to resist bending and rotation, providing steric hindrance to prevent droplet coalescence; and
(iv) a suspending agent to facilitate suspension of said particles in the formulation.

2. The formulation of claim 1, wherein said formulation includes at least 5 wt %, preferably at least 30 wt %, of the solid polymer, and/or less than 70 wt % of the solid polymer; and includes at least 1 wt %, preferably at least 5 wt %, of the inverse emulsion, and/or less than 70 wt % of the inverse emulsion.

3. The formulation of claim 1, wherein said formulation includes up to 2 wt % suspending agents, 0.5-1 wt % thinning agent, and 0.1-7 wt % dispersant.

4. The formulation of claim 3, wherein the inverse emulsion comprises at least 10 wt % and less than 80 wt % of oil phase, and at least 10 wt % and less than 70 wt % of the water-soluble polymer.

5. The formulation of claim 1, wherein said inverse emulsion includes 10-40 wt % oil phase, 15-60 wt % polymer (B), and 5-40 wt % water.

6. The formulation of claim 1, wherein the water-soluble polymer includes one or more moieties selected from —C(O)NH₂, —COO—, sulfonate, pyrrolidone, and quaternary ammonium repeat units.

7. The formulation of claim 1, wherein the solid polymer includes a repeat unit of saccharide.

8. The formulation of claim 1, wherein the solid polymer includes a repeat unit of ethylene glycol.

9. The formulation of claim 1, wherein the solid polymer is a polyacrylamide selected from anionic or neutral polyacrylamides.

10. The formulation of claim 1, wherein the solid polymer has a molecular weight of at least 1,000 Daltons, preferably at least 8,000,000 Daltons.

11. The formulation of claim 1, wherein the solid polymer is dispersed in the hydrophobic solvent as solid discrete particles in powder, granule, or flake form.
